(19) United States
(12) Patent Application Publication
(10) Pub. No.: US 2004/0080574 A1
(43) Pub. Date: Apr. 29, 2004

(54) Ink jet printer, image recording method, ink for ink jet printer and recording head

(75) Inventor: Satoshi Masumi, Tokyo (JP)

Correspondence Address: COHEN, PONTANI, LIEBERMAN & PAVANE, Suite 1210, 551 Fifth Avenue, New York, NY, 10176, US

(73) Assignee: Konica Corporation, Tokyo (JP)

(21) Appl. No.: 10/644,233

(22) Filed: Aug. 20, 2003

(30) Foreign Application Priority Data
Aug. 29, 2002 (JP) 2002-250473

(51) Int. Cl. B41J 2/14

(52) U.S. Cl. 347/47

(57) ABSTRACT

An ink jet printer includes: a recording head on which a plurality of nozzles for jetting ink are arranged; and a feeding member for feeding a recording medium, wherein an image is recorded by jetting the ink from the nozzles of the recording head to the recording medium fed by the feeding member; wherein a jetting opening of each nozzle, from which the ink is jetted, has a diameter of not less than 12 μm and not more than 22 μm, and the ink substantially includes no volatile component.

### BACKGROUND OF THE INVENTION

1. Field of the Invention

The invention relates to an ink jet printer, an image recording method, ink for the ink jet printer and a recording head.

2. Description of Related Art

Recently, an image printing method using an ink jet method has been often used to easily print an image at low cost. In a printing device (hereinafter, called “ink jet printer”) using an ink jet method, for example, as known as an on-demand method, a very small liquid drop of ink is jetted from a nozzle of a recording head toward a recording medium such as a paper by using a piezo element or a heater, and the recording head is moved above the recording medium while the ink permeates into or is fixed to the recording medium. Therefore, an image is printed on the recording medium.

In short, in the on-demand method, an image corresponding to image data is recorded on the recording medium by jetting or not jetting a liquid drop of ink according to the image data.

Also, the downsizing of an ink dot has been examined to record an image at further high quality. To downsize the ink dot, it is required to further minify the liquid drop of ink as compared with that in an earlier development. Therefore, as a means for jetting a drop of ink in appropriate minimum liquid quantity, for example, it is known that the diameter of the ink nozzle is minified by setting a nozzle diameter to a value not more than 30 μm (Published Unexamined Japanese Patent Application No. 2000-141655A (page 2). Hereinafter, the above Japanese Patent Application is called “first patent literature”).

Also, it is known that ink usually used for the ink jet printer includes pigment and a solvent and the ink includes a volatile component as the solvent.

In the ink jet printer in the earlier development, the nozzle diameter is not so small. Therefore, even though ink supplied into the nozzle includes a volatile component, volatilization of the volatile component does not influence on the ink.

However, as disclosed in the first patent literature, when the nozzle diameter is small, volatilization of the volatile component considerably influences on the ink. In detail, when the nozzle diameter is small, ink in the nozzle has an appropriately-small liquid quantity. In this case, even though a very small quantity of volatile component is volatilized, viscosity of the ink is considerably increased, or pigment of the ink is deposited. Therefore, the surface of the liquid drop of ink supplied into the nozzle is considerably deformed, or the nozzle is clogged up with the ink. As a result, no jetting of the ink from the nozzle (the clogging of the nozzle opening) is caused. Accordingly, a problem has arisen that portions of the recording medium, which are not printed due to the non-jetting nozzle are generated in stripes, the ink printed on the recording medium becomes uneven in concentration, and the quality of characters printed on the recording medium is lowered.

### SUMMARY OF THE INVENTION

In order to solve the above problem, an object of the present invention is to provide an ink jet printer, an image recording method, ink for the ink jet printer and a recording head in which an image is formed at high quality by jetting ink in appropriately-small liquid quantity without uneven concentration of the jetted ink or the lowering of quality of characters caused by the clogging of the nozzle opening.

In order to accomplish the above-mentioned object, in accordance with the first aspect of the present invention, an ink jet printer comprises:

a recording head on which a plurality of nozzles for jetting ink are arranged; and

a feeding member for feeding a recording medium,

wherein an image is recorded by jetting the ink from the nozzles of the recording head to the recording medium fed by the feeding member;

wherein a jetting opening of each nozzle, from which the ink is jetted, has a diameter of not less than 12 μm and not more than 22 μm, and the ink substantially includes no volatile component.

In the first aspect of the present invention, the jetting opening of each nozzle, from which the ink is jetted, has a diameter equal to or more than 12 μm and not more than 22 μm, and the ink substantially includes no volatile component. Therefore, there is no probability that the considerable increase of viscosity of the ink or the deposit of pigment of the ink is caused by the volatilization of the ink. Therefore, no clogging of the nozzle opening occurs, and the ink can be jetted from the jetting opening of a small diameter in appropriately-small liquid quantity. Also, uneven concentration of the jetted ink and the lowering of quality of characters are prevented, and an image can be formed at high quality.

Here, when the diameter (nozzle diameter) of the jetting opening is smaller than 12 μm, the clogging-up of the nozzle occurs easily, and an image cannot be stably obtained at high quality. Also, when the diameter of the jetting opening is larger than 22 μm, the ink cannot be jetted as a small drop of liquid. Therefore, an image cannot be obtained at high quality. Also, the actuation condition (actuation pattern) for jetting a small drop of liquid is limited, and it is difficult to jet the ink at high speed.

It is preferred that a volume of a drop of the ink jetted from the nozzle is not less than 1 pico-liter and not more than 6 pico-liter.

In this invention, because the quantity of a drop of the ink jetted from the nozzle is equal to or more than 1 pico-liter and not more than 6 pico-liter, the diameter of a dot formed by jetting the ink can be minified, and an image can be printed at high definition and in proper concentration.

Here, when a drop of the ink is smaller than 1 pico-liter, the intensity of the formed image is excessively low. When a drop of the ink is larger than 6 pico-liter, it becomes difficult to print an image at high definition.

It is preferred that a supply opening side of each nozzle, to which the ink is supplied, differs from a jetting opening side of each nozzle in an angle of an inner circumferential surface of the nozzle with respect to a center line of the nozzle.

In this invention, the angle of the inner circumferential surface of the nozzle on the side of the supply opening with respect to the center line of the nozzle differs from that on the side of the jetting opening. Here, for example, shapes of the nozzles shown in FIGS. 3B, 6 and 7 are presented.

In detail, in FIG. 3B, the nozzle on the side of the supply opening is formed in a taper shape in which the nozzle is narrowed along a jetting direction of the ink, and the nozzle on the side of the jetting opening is almost parallel to the center line (the jetting direction of the ink) of the nozzle. Therefore, when the nozzle on the side of the supply opening is formed in the taper shape, foreign bodies such as dust and air bubbles held in the nozzle are absorbed and can be easily removed from the jetting opening. Also, because of the taper shape, an actuating voltage can be lowered, so that the temperature of the nozzle can be lowered. Therefore, no clogging of the nozzle opening occurs due to the change of properties of the ink caused by the increase of the temperature. As a result, the ink can be jetted in appropriately-small liquid quantity, and the image can be formed at high quality.

Also, the inner circumferential surface of the nozzle on the side of the jetting opening is almost parallel to the center line of the nozzle. Therefore, as shown in FIG. 8, as compared with a case that the angle of the inner circumferential surface on the side of the supply opening is the same as that on the side of the jetting opening, the strength in the jetting opening can be secured. In addition, in case of FIG. 8, because the quantity of the ink jetted from the jetting opening is considerably changed due to the manufacturing error of the inclined angle in the jetting opening, the quantity of the jetted ink and the jetting direction cannot be stabilized. However, as shown in FIG. 3B, when the inner circumferential surface of the nozzle on the side of the jetting opening is almost parallel to the center line of the nozzle, the quantity of the jetted ink can be preferably stabilized, and the jetting direction can be stabilized.

In FIG. 6, the inner circumferential surface of the nozzle on the side of the supply opening is almost parallel to the center line (the jetting direction of the ink) of the nozzle, and the nozzle on the side of the jetting opening is formed in the taper shape in which the nozzle is widened along the jetting direction of the ink. Also, in FIG. 7, the nozzle on the side of the supply opening is formed in the taper shape in which the nozzle is narrowed along the jetting direction of the ink, and the nozzle on the side of the jetting opening is formed in the taper shape in which the nozzle is widened along the jetting direction.

As described above, because the nozzle on the side of the jetting opening is formed in the taper shape widening the nozzle along the jetting direction, the clogging-up of the jetting opening with the ink can be prevented. In detail, for example, after the jetting of the ink to the recording medium, a UV lamp (active energy ray radiating member) arranged in the neighborhood of the jetting opening radiates UV light (ultraviolet rays) to the recording medium to harden the ink. In this case, all the UV light is not absorbed in the recording medium, and a part of the UV light is scattered by the recording medium. Therefore, there is a case that the scattered light is reflected on the jetting opening and hardens the ink placed in the neighborhood of the jetting opening. However, as described above, because the nozzle on the side of the jetting opening is formed in the taper shape widening the nozzle along the jetting direction, as compared with the case of FIG. 8, the clogging-up of the jetting opening due to the hardening of the ink hardly occurs.

As described above, in the invention (FIGS. 3B, 6 and 7), because the nozzle is formed on condition that the angle of the inner circumferential surface of the nozzle on the side of the supply opening with respect to the center line of the nozzle differs from that on the side of the jetting opening, at least one of the above-described effects can be obtained.

It is preferred that the ink jet printer further comprises a head temperature adjusting mechanism arranged in the neighborhood of the jetting opening, for adjusting a temperature of the ink at the jetting opening to not less than 30° C.

In this invention, when the ink is jetted from the jetting opening, temperature of the ink is adjusted to be equal to or more than 30° C. by the head temperature adjusting mechanism. Therefore, even though viscosity of the ink is high at a low temperature near to a room temperature, the viscosity of the ink is maintained to an optimum value, and the ink can be stably jetted from the jetting opening. Accordingly, the image can be formed at high image quality and high efficiency.

Here, when temperature of the ink is lower than 30° C., because the ink has a high viscosity, it is difficult to jet the ink from the jetting opening, and the clogging-up of the jetting opening occurs.

It is preferred that a viscosity of the ink is not less than 20 mPa.s and not more than 200 mPa.s at 25° C., and the viscosity of the ink is not less than 8 mPa.s and not more than 30 mPa.s when the ink is jetted from each nozzle.

In this invention, because the viscosity of the ink is equal to or more than 20 mPa.s and not more than 200 mPa.s s at temperature of 25° C., after receiving the jetted ink on the recording medium, the ink can sticks to the recording medium and can be appropriately leveled on the recording medium. Therefore, an image can be formed at high quality while the shape of each ink dot formed of the jetted ink on the recording medium is easily controlled, and the image formed on the recording medium can be largely strengthened.

Here, when viscosity of the ink is less than 20 mPa.s at temperature of 25° C., the ink bleeds on the recording medium. When viscosity of the ink is more than 200 mPa.s at temperature of 25° C., the smoothness of the ink in the image quality is lost.

Also, because viscosity of the ink is equal to or more than 8 mPa.s and not more than 30 mPa.s in the jetting of the ink, the clogging-up of the jetting opening can be prevented, and the ink can be smoothly jetted. Therefore, the image of the high quality can be formed at high efficiency.

Here, when viscosity of the ink is less than 8 mPa.s in the jetting of the ink, it is required to further heighten the temperature of the ink. Therefore, the agglomeration of the ink occurs due to the thermosetting of the ink, and the durability of the nozzle deteriorates. When viscosity of the ink is more than 30 mPa.s, the jetting property of the ink deteriorates.

It is preferred that the ink includes an active energy ray curable compound.

Also, it is preferred that the ink jet printer further comprises an active energy ray radiating member for radiating an active energy ray to the recording medium to which the ink is jetted from the nozzle, in order to harden the active energy ray curable compound.

In this invention, when the active energy ray radiating member radiates an active energy ray to the recording medium, the active energy ray curable compound included in the ink is hardened, and the jetted ink can be received on and stick to the recording medium.

In accordance with the second aspect of the present invention, an image recording method comprises: forming an image by jetting ink to a recording medium with the above-described ink jet printer.

In the second aspect of the present invention, there is no probability that the considerable increase of viscosity of the ink or the deposit of pigment of the ink is caused by the volatilization of the ink. Therefore, no clogging of the nozzle opening occurs, and the ink can be jetted from the jetting opening of a small diameter in appropriately-small liquid quantity. Also, uneven concentration of the jetted ink and the lowering of quality of characters are prevented, and an image can be formed at high quality.

In accordance with the third aspect of the present invention, a recording head comprises a plurality of nozzles for jetting ink,

wherein a jetting opening of each nozzle, from which the ink is jetted, has a diameter of not less than 12 μm and not more than 22 μm.

Preferably, a volume of a drop of the ink jetted from the nozzle is not less than 1 pico-liter and not more than 6 pico-liter.

It is preferred that a supply opening side of each nozzle, to which the ink is supplied, differs from a jetting opening side of each nozzle in an angle of an inner circumferential surface of the nozzle with respect to a center line of the nozzle.

It is preferred that the recording head further comprises a head temperature adjusting mechanism arranged in the neighborhood of the jetting opening of the nozzle, for adjusting a temperature of the ink at the jetting opening to not less than 30° C.

In accordance with the fourth aspect of the present invention, ink for an ink jet printer includes color material, and the ink substantially includes no volatile component.

Preferably, a viscosity of the ink is not less than 20 mPa.s and not more than 200 mPa.s at 25° C., and the viscosity of the ink is not less than 8 mPa.s and not more than 30 mPa.s when the ink is jetted from a nozzle of the ink jet printer.

Also, it is preferred that the ink includes an active energy ray curable compound.

### BRIEF DESCRIPTION OF THE DRAWINGS

The present invention will become more fully understood from the detailed description given hereinbelow and the accompanying drawing which are given by way of illustration only, and thus are not intended as a definition of the limits of the present invention, and wherein;

FIG. 1 is an explanatory side view of a main part of an ink jet printer according to the present invention;

FIG. 2A is a sectional view of a recording head according to the present invention, and FIG. 2B is an enlarged sectional view taken substantially along line (i)-(i) of FIG. 2A;

FIG. 3A is a perspective view of a nozzle plate according to the present invention, and FIG. 3B is an enlarged sectional view taken substantially along line (ii)-(ii) of FIG. 3A;

FIG. 4 is a view showing a modification of FIG. 3B;

FIG. 5 is a view showing a modification of FIG. 3B;

FIG. 6 is a view showing a modification of FIG. 3B;

FIG. 7 is a view showing a modification of FIG. 3B; and

FIG. 8 is a view showing a modification of FIG. 3B.

### PREFERRED EMBODIMENTS OF THE INVENTION

Hereinafter, an ink jet printer according to the embodiment of the present invention will be explained with reference to the drawings. As an ink jet printer according to the embodiment, an ink jet printer for performing the image formation by jetting ultraviolet (UV) ink having the property of being hardened by receiving ultraviolet rays, on a recording medium will be explained as an example. However, the ink jet printer according to the present invention is not limited to that using the UV ink.

As described later, on condition that a type of ink substantially including no volatile component is used for the ink jet printer, ink (ink including an active energy ray curable compound) having the property of being hardened by receiving an active energy ray such as infrared rays, visible rays, an electron beam or X rays can be used. Here, the active energy ray is not limited to the flux (for example, electron beam) having an ability of ionizing air, but includes an electromagnetic wave such as infrared rays, visible rays and ultraviolet rays.

As ink including no volatile component, for example, UV ink, oil or hot melt ink is used.

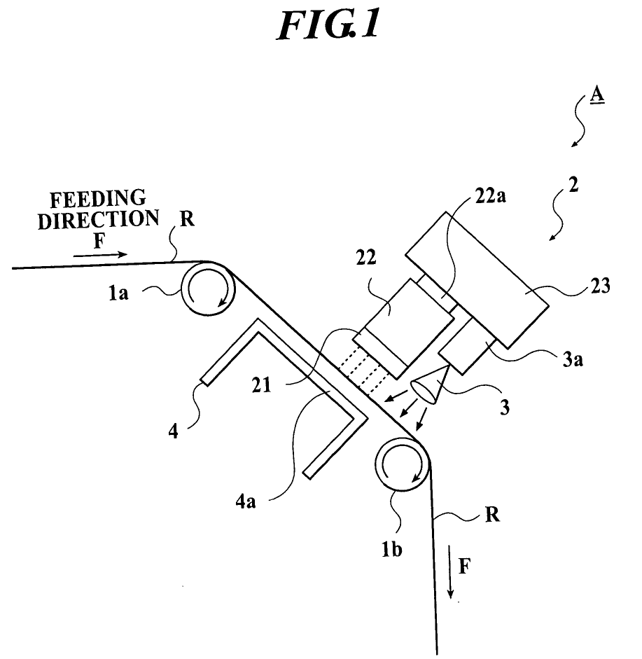

FIG. 1 is an explanatory side view of a main part of an ink jet printer. The image formation on a recording medium will be easily realized with reference to FIG. 1.

As shown in FIG. 1, an ink jet printer A roughly comprises feeding rollers (feeding member) 1a and 1b for feeding a recording medium R such as a sheet of paper, a resin film or the like, an image forming section 2 for performing the image formation on the recording medium R fed by the feeding rollers 1a and 1b, a UV lamp (radiating member) 3 for radiating ultraviolet rays to the recording medium R to which ink sticks by the image forming section 2, and a guide member 4 for guiding the recording medium R in a feeding direction F. The recording medium R fed by the feeding roller 1a passes through the image forming section 2 and is fed by the feeding roller 1b. This feeding path of the recording medium R is set along the feeding direction F by the feeding rollers 1a and 1b.

Here, in this embodiment, as an example, a roll of resin film (thin-filmed plastic film) is applied as a paper supply source. This roll of resin film is expressed as “recording medium R”. Also, the recording medium R is not limited to the roll of resin film, and it is applicable that the recording medium R be formed of a sheet of resin film. Also, it is applicable that the recording medium R be formed of one of various types of papers or one of various types of cloths or nonwoven fabric cloths. Also, it is applicable that the recording medium R be formed out of another material such as metal. Also, the recording medium R is not limited to a sheet, but it is applicable that the recording medium R be formed in a plate shape.

As shown in FIG. 1, the feeding rollers 1a and 1b placed away from each other are respectively arranged in front of and in the rear of the image forming section 2 in which the image formation is performed for the recording medium R. The feeding rollers 1a and 1b are rotated in the same direction and feed out the recording medium R in the feeding direction F. Therefore, the feeding rollers 1a and 1b feed the recording medium R from a UV ink reaching position to an ultraviolet rays receiving position.

The image forming section 2 comprises a plurality of ink jet type recording heads 21, a carriage 22 holding the recording heads 21, and a carriage rail 23 for leading the movement of the carriage 22. The recording heads 21 are described later in detail.

The carriage 22 holds the recording heads 21 and is connected to the carriage rail 23 through a connecting unit 22a. The carriage rail 23 extends in a direction almost orthogonal to the feeding direction F of the recording medium R and leads the carriage 22 in the direction (from the front side to the back side or from the rear side to the front side in the paper of FIG. 1) almost orthogonal to the feeding direction F. Hereinafter, the extending direction of the carriage rail 23 is called “scanning direction”.

When the image formation is performed on the recording medium R, UV ink is jetted from one recording head 21 to the recording medium R while the carriage 22 lead by the carriage rail 23 is moved in the scanning direction.

After the image formation performed in the image forming section 2, the UV lamp (active energy ray radiating section) 3 radiates ultraviolet rays on an image forming surface of the recording medium R to which the UV ink sticks. The UV ink sticking to the recording medium R is hardened due to the radiation of the ultraviolet rays. Here, in FIG. 1, the UV lamp 3 is fixed to the carriage rail 23 through the connecting unit 3a, and the single UV lamp 3 is arranged on the downstream side of the recording heads 21 in the feeding direction F. However, it is applicable that the UV lamp 3 moved with the recording heads 21 be arranged at a position which is adjacent to the recording heads 21 moved in the feeding direction F and is determined according to the number of recording heads 21.

The guide member 4 is made of a plate member having a width which is the same as or longer than that of the recording medium R. This guide member 4 is placed oppositely to the recording heads 21, supports the recording medium R, on which the image formation is performed by the recording heads 21, from the side of a non-image forming surface and guides the recording medium R in the feeding direction F. Here, the “non-image forming surface” denotes a surface opposite to the image forming surface of the recording medium R and denotes a surface on which no image formation is performed.

In detail, a portion of the guide member 4 placed oppositely to the recording heads 21 functions as a platen 4a. A vacuum chamber (not shown) is arranged on the back side of the platen 4a, and a vacuum nozzle (not shown) having a plurality of small holes and lead to the vacuum chamber is arranged. When the image formation is performed by the recording heads 21, the platen 4a sucks and holds the non-image forming surface of the recording medium R.

When the constitutional elements described above are combined with each other, the recording medium R fed by the feeding rollers 1a and 1b is supported by the guide member 4 from the side of the non-image forming surface thereof, and the UV ink is jetted from the recording head 21 to the image forming surface of the recording medium R while the carriage 22 is moved in the scanning direction. Therefore, the image formation is performed.

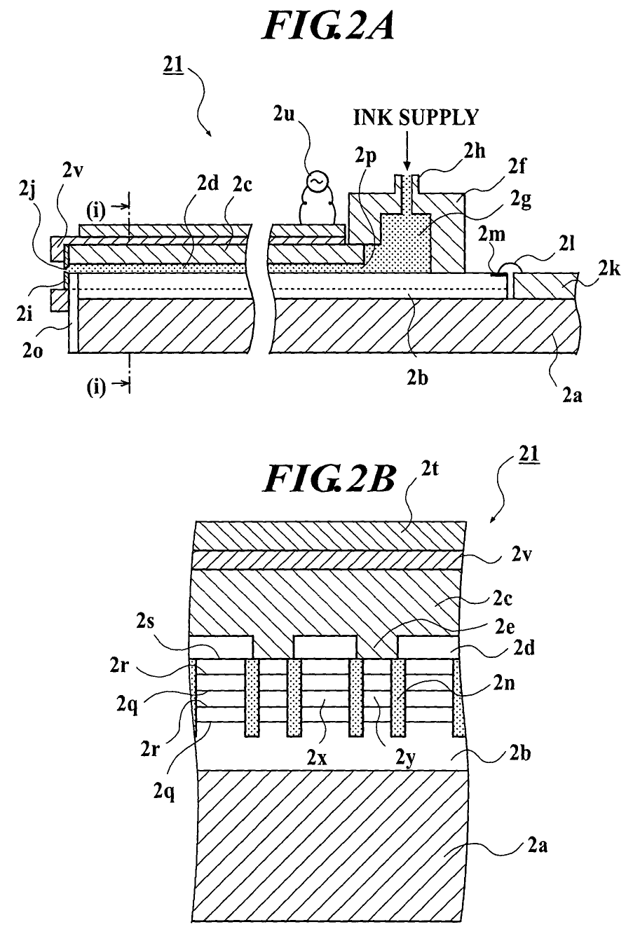

Next, the configuration of the recording head 21 will be explained. FIG. 2A is a sectional view of the recording head 21, and FIG. 2B is an enlarged sectional view taken substantially along line (i)-(i) of FIG. 2A.

As shown in FIGS. 2A and 2B, the recording head 21 comprises a substrate 2a, a piezoelectric element 2b, a channel board 2c, ink channels 2d, walls 2e, a common liquid chamber constitutional member 2f, a common liquid chamber 2g, an ink supply pipe 2h, a nozzle plate 2i, nozzles 2j, an actuation print circuit board (PCB) 2k, lead lines 2l, actuation electrodes 2m, grooves 2n, a protection board 2o, fluid resistances 2p, electrodes 2q and 2r, an upper barrier plate 2s, a heater 2t, a heater power source 2u and a heat transfer member 2v.

In the integrated recording head 21, grooves are formed in the piezoelectric element 2b having the laminated electrodes 2q and 2r in the extending direction of the ink channel 2d, and the piezoelectric element 2b is partitioned into the grooves 2n, actuating piezoelectric elements 2x and non-actuating piezoelectric elements 2y. The grooves 2n is sealed with filling material. The channel board 2c is fitted to the piezoelectric element 2b through the upper barrier plate 2s. The upper barrier plate 2s is supported by the non-actuating piezoelectric elements 2y and the walls 2e respectively dividing the ink channels 2d adjacent to each other. The width of the actuating piezoelectric element 2x is slightly narrower than that of the ink channel 2d. When a pulse-shaped signal voltage is applied to one actuating piezoelectric element 2x selected by an actuation circuit of the actuation print circuit board (PCB) 2k, the shape of the actuating piezoelectric element 2x is changed in a thickness direction. Therefore, the volume of the ink channel 2d adjacent to the actuating piezoelectric element 2x through the upper barrier plate 2s is changed. As a result, a drop of ink is jetted from the nozzle 2j of the nozzle plate 2i.

The heater 2t is fitted on the channel board 2c through the heat transfer member 2v. The heat transfer member 2v is arranged so as to surround surfaces of the nozzles 2j. The heat transfer member 2v efficiently transfers the heat generated in the heater 2t to the channel board 2c to heat the ink of the ink channels 2d. Also, the heat transfer member 2v efficiently transfers the heat of the heater 2t to areas neighboring the surfaces of the nozzles 2j to heat air placed in the neighborhood of the surfaces of the nozzles 2j. Therefore, the heat transfer member 2v is made of material having a high heat conductivity. For example, the heat transfer member 2v is preferably made of metal such as aluminum, iron, nickel, cupper or stainless steel or made of a ceramic of SiC, BeO or AlN.

When the piezoelectric element 2b is actuated for the liquid ink, the actuating piezoelectric element 2x is expanded in a direction perpendicular to the longitudinal direction of the ink channel 2d, the volume of the ink channel 2d is changed, and the ink of the ink channel 2d is jetted as a drop of ink from the nozzle 2j due to the volume change. Here, a signal is sent to the piezoelectric element 2b to always shrink each ink channel 2d. When one ink channel 2d is selected, a pulse signal is sent to the piezoelectric element 2b to increase at first the volume of the selected ink channel 2d due to the displacement of the piezoelectric element 2b and to decrease secondly the volume of the selected ink channel 2d due to the displacement of the piezoelectric element 2b after the increase of the volume. Therefore, the ink is jetted as a drop of ink from the nozzle 2j corresponding to the ink channel 2d.

Also, the recording head 21 has a temperature adjusting mechanism (not shown), and the temperature adjusting mechanism adjusts the temperature of the recording head 21 to an optimum value to set viscosity of the UV ink supplied to the recording head 21 to a value optimum to the jetting.

The temperature of the UV ink is maintained within a range from 30° C. to 150° C. to jet the ink having low viscosity. Therefore, the jetting stability of the ink can be obtained. Preferably, the temperature of the UV ink is maintained within a range from 40° C. to 100° C.

When the temperature of the UV ink is lower than 30° C., the viscosity of the UV ink is heightened. Therefore, the UV ink cannot be stably jetted from the nozzle 2j. In contrast, when the temperature of the UV ink exceeds 150° C., electric power required for the temperature adjustment of the UV ink is increased. Therefore, a problem has arisen that electric power consumed in the whole ink jet printer A is increased.

Radiation hardening ink like the UV ink has viscosity higher than that of water-color ink. Therefore, a degree of the change of viscosity caused by the temperature change is large in the radiation hardening ink. The change of viscosity directly and considerably influences on the size of the drop of liquid and the jetting speed of the drop of liquid, and the image quality deteriorates. Therefore, the maintenance of the ink temperature to a constant value is required within the range of possibility. The ink is usually controlled to a setting temperature while allowing a temperature change within a range of ±5° C. Preferably, the temperature change is within a range of ±2° C. More preferably, the temperature change is within a range of ±1° C. A pipe system and all members in the range from the common liquid chamber 2g to the nozzles 2j are set to a constant temperature by a head temperature adjusting mechanism.

The head temperature adjusting mechanism comprises a head temperature sensor (head temperature detecting member), arranged in the common liquid chamber 2g of the recording head 21, for detecting the temperature of the ink, a heater (ink-in-head heating member), arranged in or outside the common liquid chamber 2g, for heating the ink, and a head temperature control section.

The head temperature control section comprises an interface, a CPU and a memory not shown. Various types devices (the head temperature sensor and the heater) connected to the interface are controlled according to a control program or control data written in the memory.

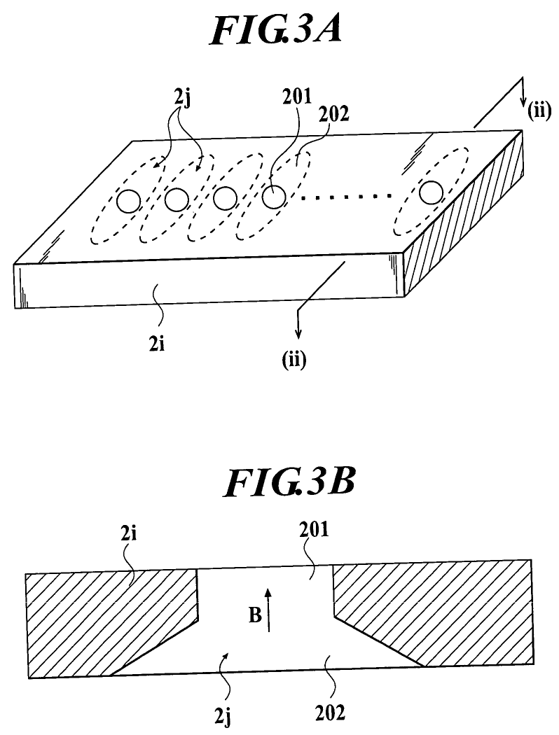

Thereafter, the CPU performs the arithmetic calculation according to various data (flow rate of ink and the like) written in the memory and the temperature detected by the head temperature sensor and controls the temperature of the UV ink at a jetting opening 201 (refer to FIGS. 3A and 3B) by controlling the heater to set the temperature of the UV ink at the jetting opening 201 within the above-described range (from 30° C. to 150° C.) and to set the viscosity of the UV ink to an optimum value.

Also, it is preferred that the recording heads 21 are shielded or insulated from the heat to receive no influence of the heat of the printer or the open air. Also, to shorten a printer setup time required for the heating and to reduce the loss of the heating energy, it is preferred that the recording heads 21 are insulated from the other elements and a heat capacity of the whole heating unit is lowered.

Next, the jetting opening 201 of the nozzle 2j of the nozzle plate 2i indicating the feature of the present invention will be explained. FIG. 3A is an oblique view of the nozzle plate 2i, and FIG. 3B is an enlarged sectional view taken substantially along line (ii)-(ii) of FIG. 3A.

As shown in FIGS. 3A and 3B, each nozzle 2j comprises a supply opening 202 to which the ink is supplied, and a jetting opening 201 from which the ink is jetted. An angle of an inner circumferential surface on the side of the supply opening 202 with respect to a center line of the nozzle 2j differs from that on the side of the jetting opening 201.

In detail, in a side view of the nozzle 2j in cross section, the supply opening 202 is formed in a taper shape in which the nozzle 2j is narrowed along a jetting direction B on the side of the supply opening 202, and the inner circumferential surface on the side of the jetting opening 201 straightly extends almost in parallel to the center line (a jetting direction B) of the nozzle 2j. Also, in a plane view of the nozzle 2j in cross section, the supply opening 202 is formed in an elliptical shape, and the jetting opening 201 is formed in a truly circular shape (refer to FIG. 3A).

Because the side of the supply opening 202 of the nozzle 2j is formed in the taper shape, it is possible that foreign bodies such as dust and air bubbles held in the nozzle 2j are absorbed to the jetting opening 201 and are easily removed from the jetting opening 201. Also, because an actuating voltage can be lowered, no clogging of the nozzle opening occurs, the ink can be jetted in appropriately-small liquid quantity, and the image can be formed at high quality.

Also, because the inner circumferential surface on the side of the jetting opening 201 extends almost in parallel to the center line of the nozzle 2j, the strength in the jetting opening 201 can be secured as compared with a case shown in FIG. 8 in which an angle of the inner circumferential surface with respect to the center line of the nozzle 2j is constant on both sides of a supply opening 202e and a jetting opening 201e. In addition, a quantity of the jetted ink can be preferably stabilized, and a jetting direction of the ink can be stabilized.

Also, the diameter (nozzle diameter) of the jetting opening 201 is set to be equal to or more than 12 μm and not more than 22 μm, and this nozzle diameter is the feature of the present invention.

Here, assuming that the diameter (nozzle diameter) of the jetting opening 201 is smaller than 12 μm, the clogging-up of the nozzle 2j easily occurs, and the image cannot be stably formed at high quality. Also, assuming that the diameter (nozzle diameter) of the jetting opening 201 is larger than 22 μm, the ink cannot be jetted as a small drop of liquid. Therefore, the image cannot be stably formed at high quality. Also, the actuation condition (actuation pattern) for jetting a small drop of liquid is limited, and it is difficult to jet the ink at high speed.

Also, the nozzles 2j are generally formed by making a plurality of holes in the nozzle plate 2i made of polyimide resin according to a laser abrasion. To arrange the nozzles 2j in high density, it is preferred that the length of the nozzle 2j in a direction toward an adjacent nozzle is shortened and the length of the nozzle 2j in a direction perpendicular to a direction toward an adjacent nozzle is lengthened.

Here, modifications of the supply opening 202 and the jetting opening 201 of the nozzle 2j in point of the shape in the side view in cross section will be explained.

In FIG. 4, as compared with the inner circumferential surface formed in the taper shape on the side of the supply opening 202 in FIG. 3B, the inner circumferential surface on the side of a supply opening 202a is curved so as to swell toward the ink channel. Though the inner circumferential surface on the side of a jetting opening 201a is almost parallel to the jetting direction B, the side of the jetting opening 201a is slightly widened toward the side of the supply opening 202a.

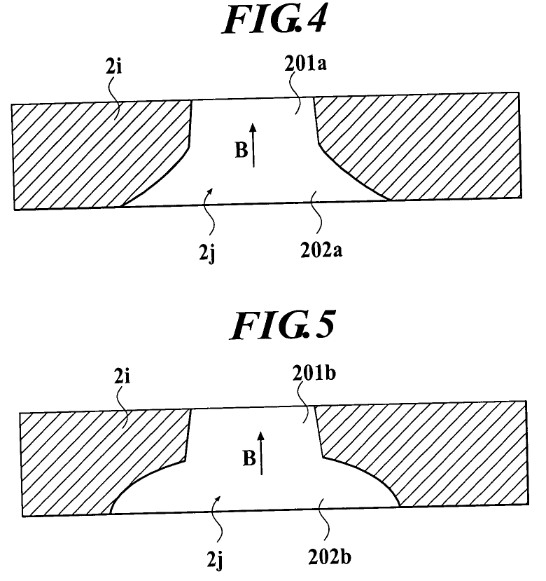

In FIG. 5, as compared with the inner circumferential surface formed in the taper shape on the side of the supply opening 202 in FIG. 3B, the inner circumferential surface on the side of a supply opening 202b is curved so as to swell toward the nozzle plate 2i. Though the inner circumferential surface on the side of a jetting opening 201b is almost parallel to the jetting direction B, the inner circumferential surface on the side of the jetting opening 201b is slightly widened toward the side of the supply opening 202b.

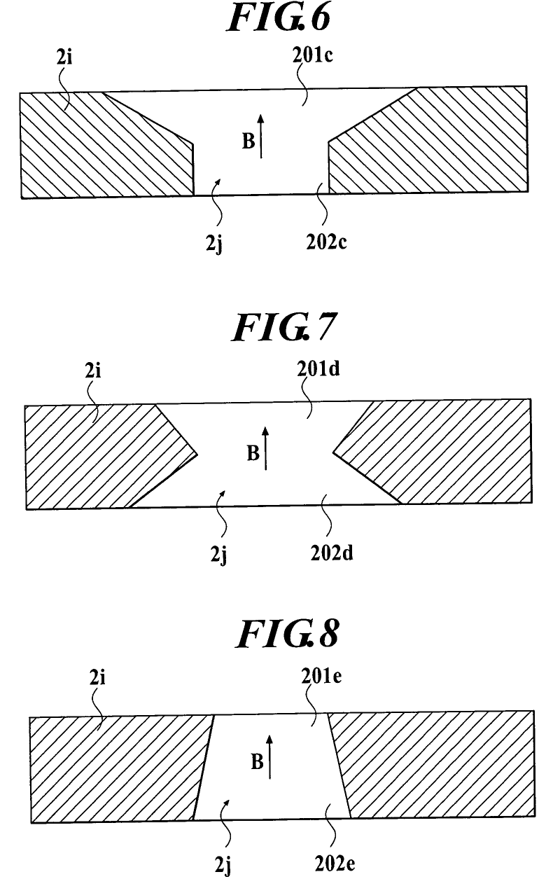

In FIG. 6, the inner circumferential surface on the side of a supply opening 202c straightly extends in almost parallel to the center line of the nozzle 2j, and the inner circumferential surface on the side of a jetting opening 201c is formed in the taper shape so as to be widened along the jetting direction B of the ink.

In FIG. 7, the inner circumferential surface on the side of a supply opening 202d is formed in the taper shape so as to be narrowed along the jetting direction B of the ink, and the inner circumferential surface on the side of a jetting opening 201d is formed in the taper shape so as to be widened along the jetting direction B of the ink.

Here, in a plane view of the nozzle 2j in cross section, the supply openings 202a to 202d shown in FIGS. 4 to 7 are respectively formed in the elliptical shape, and the jetting openings 201a to 201d are respectively formed in the truly circular shape.

As shown in FIGS. 6 and 7, the inner circumferential surfaces on the sides of the jetting openings 201c and 201d are respectively formed in the taper shape in the jetting direction B of the ink, the clogging-up of the jetting openings 201c and 201d hardly occurs. In detail, there is a probability that the ink placed in the neighborhood of the jetting openings 201c and 201d is hardened when scattered light of the ultraviolet rays radiated from the UV lamp 4 is reflected on the jetting openings 201c and 201d. However, as compared with the jetting opening shown in FIG. 3B, the clogging-up of the jetting openings 201c and 201d can be prevented.

Accordingly, it is preferred that the nozzle 2j is formed in one shape selected from the shapes of the FIGS. 3B to 7. Also, more preferably, the nozzle 2j shown in FIG. 3B is adequate.

Next, the inks used for the above ink jet printer A are described.

The inks of the invention are the inks which substantially include no volatile component. That is, they refer to the inks where a content of water or an organic solvent having a boiling point of 150° C. or below is less than 1%. When the volatile component is included at 1% or more, a viscosity is increased by volatilization of the volatile component and pigments are precipitated, which become causes of the clogging-up at a jetting opening. Such inks include UV inks, oils, hot melt inks and the like.

### Viscosity of Inks

It is preferred that the viscosity of the inks of the invention is from 20 to 200 mPa.s at 25° C. When the viscosity of the ink is less than 20 mPa.s, the ink bleeds on the recording medium. When viscosity of the ink is more than 200 mPa.s, the smoothness of the ink in the image quality is lost.

Also, it is preferred that a temperature of the ink is adjusted in the jetting of the ink and the viscosity at the temperature in the jetting of the ink is from 8 to 30 mPa.s, and it is more preferably from 8 to 20 mPa.s. When it is less than 8 mPa.s, the agglomeration of the ink occurs due to the thermosetting of the ink and the durability of the nozzle deteriorates because the temperature of nozzle becomes high. When it is more than 30 mPa.s, the jetting property of the ink deteriorates.

### Photopolymerizable Compound, Photopolymerization Initiator

It is preferred that the inks of the invention is the inks containing an active energy ray curable compound. As the photopolymerizable compound used for the inks, the photocurable type materials using radical polymerizable compounds (e.g., the photopolymerizable compositions described in Japanese Patent Applications No. 7-159983A, No. 7-31399B, No. 8-224982A and No. 10-863A and the like) and photo curable resins of the cationic polymerization system are known. In recent, photo curable resins of the photo cationic polymerization system, which are sensitized to an equivalent to or longer wavelength area than a visible light area have been disclosed, for example, in Japanese Patent Applications No. 6-43633A and No. 8-324137A.

The radical polymerizable compounds are the compounds having ethylene unsaturated bonds capable of radical polymerization, may be any of those as long as the compound has at least one ethylene unsaturated bond capable of radical polymerization in the molecule, and also include those having chemical forms such as monomer, oligomer and polymer. The radical polymerizable compound may be used alone or in combination with two or more at any ratio to improve aimed properties.

Examples of the compounds having ethylene unsaturated bonds capable of radical polymerization include unsaturated carboxylic acids such as acrylic acid, methacrylic acid, itaconic acid, crotonic acid, isocrotonic acid and maleic acid, salts, esters, urethane, amide and anhydrides thereof; acrylonitrile; styrene; and further radical polymerizable compounds such as various unsaturated polyesters; unsaturated polyethers; unsaturated amides; and unsaturated urethanes. Specifically acrylate derivatives such as 2-ethylhexyl acrylate, 2-hydroxyethyl acrylate, butoxyethyl acrylate, carbitol acrylate, cyclohexyl acrylate, tetrahydrofurfuryl acrylate, benzyl acrylate, bis (4-acryloxypolyethoxyphenyl) propane, neopentylglycol diacrylate, 1,6-hexanediol diacrylate, ethyleneglycol diacrylate, diethyleneglycol diacrylate, triethyleneglycol diacrylate, tetraethyleneglycol diacrylate, polyethyleneglycol diacrylate, polypropyleneglycol diacrylate, pentaerythritol triacrylate, pentaerythritol tetraacrylate, dipentaerythritol tetraacrylate, trimethylolpropane triacrylate, tetramethylolmethane tetraacrylate, oligoester acrylate, N-methylol acrylamide, diacetone acrylamide, and epoxy acrylate; methacrylate derivatives such as methyl methacrylate, butyl methacrylate, 2-ethylhexyl methacrylate, lauryl methacrylate, allyl methacrylate, glycidyl methacrylate, benzyl methacrylate, dimethylaminomethyl methacrylate, 1,6-hexanediol dimethacrylate, ethyleneglycol dimethacrylate, triethyleneglycol dimethacrylate, polyethyleneglycol dimethacrylate, polypropyleneglycol dimethacrylate, trimethylolethane trimethacrylate, trimethylolpropane trimethacrylate, and 2,2-bis (4-methacryloxypolyethoxyphenyl) propane; and the other, allyl compound derivatives such as allylglycidyl ethers; diallyl phthalate; and triallyl trimellitate, are included. More specifically, it is possible to use radical polymerizable or crosslinked monomers, oligomers and polymers commercially available or known in the art as described in “Crosslinker Handbook” edited by Yamashita, S., (1981, Taiseisha); “UV/EB Cure handbook (Raw material series)” edited by Kato, K., (1985, Kobunshi Kankokai); “Practical Application and Market of UV/EB Cure Technology” edited by Rad Tech Japan, page 79 (1989, CMC); and Takiyama E, “Polyester Resin Handbook” (1988, The Nikkan Kogyo Shinbun).

An amount of the above radical polymerizable compound added to the ink is preferably from 1 to 97% by mass and more preferably from 30 to 95% by mass.

Radical polymerization initiators include triazine derivatives described in Japanese Patent Applications No. 59-1281B, 61-9621B and 60-60104A, organic peroxides described in Japanese Patent Applications No. 59-1504A and No. 61-243807A, diazonium compounds described in Japanese Patent Applications No. 43-23684B, No. 44-6413B, No. 47-1604B and U.S. Pat. No. 3,567,453, organic azide compounds described in U.S. Pat. Nos. 2,848,328, 2,852,379 and 2,940,853, ortho-quinone diazides described in Japanese Patent Applications No. 36-22062B, No. 37-13109B, No. 38-18015B and No. 45-9610B, various onium compounds described in Japanese Patent Application No. 55-39162B, No. 59-14023A and Macromolecules Vol.10, page 1307 (1977), azo compounds described in Japanese Patent Application No. 59-142205A, metallic allene complexes described in Japanese Patent Application No. 1-54440A, European Patent No. 109,851, European Patent No. 126,715 and Journal of Imaging Science (J. Imag. Sci.), Vol. 30, page 174 (1986), (oxo) sulfonium organic boron complexes described in Japanese Patent Application No. 5-213861A and No. 5-255347A, titanocenes described in Japanese Patent Application No. 61-151197A, transition metal complexes containing transition metals such as ruthenium described in Coordination Chemistry Review, Vol. 84, pages 85 to 277, 1988 and Japanese Patent Application No. 2-182701A, 2,4,5-triarylimidazole dimer, carbon tetrabromide described in Japanese Patent Application No. 3-209477A, and organic halide compounds described in Japanese Patent Application No. 59-107344A.

It is preferred that these polymerization initiators are contained at the range of 0.01 to 10 parts by mass based on 100 parts by mass of the compound having the ethylene unsaturated bonds capable of radical polymerization.

Photo curable resins of the cationic polymerization system include epoxy type ultraviolet ray curable prepolymers where the polymerization occurs by cationic polymerization. Monomers can include prepolymers containing two or more epoxy groups within one molecule. Such prepolymers can include, for example, alicyclic polyepoxides, polyglycidyl esters of polybasic acids, polyglycidyl ethers of polyalcohols, polyglycidyl ethers of polyoxyalkyleneglycols, polyglycidyl ethers of aromatic polyols, hydrogenated compounds of polyglycidyl ethers of aromatic polyols, urethanepolyepoxy compounds and epoxidated polybutadienes. These prepolymers can be used alone by one type thereof or in mixture with two or more thereof.

Cationic polymerized compounds contained in cationic polymerization compositions can include, for example, the following (1) styrene derivatives, (2) vinylnaphthalene derivatives, (3) vinyl ethers and (4) N-vinyl compounds in addition to the above photo curable resins of the cationic polymerization system.

### (1) Styrene Derivatives

For example, stylene, p-methylstyrene, p-methoxystyrene, β-methylstylene, p-methyl-β-methylstyrene, α-methylstyrene, p-methoxy-β-methylstyrene and the like.

### (2) Vinylnaphthalene Derivatives

For example, 1-vinylnaphthalene, α-methyl-1-vinylnaphthalene, β-methyl-1-vinylnaphthalene, 4-methyl-1-vinylnaphthalene, 4-methoxy-1-vinylnaphthalene and the like.

### (3) Vinyl Ethers

For example, isobutylvinyl ether, ethylvinyl ether, phenylvinyl ether, p-methylphenylvinyl ether, p-methoxyphenylvinyl ether, α-methylphenylvinyl ether, β-methylisobutylvinyl ether, β-chloroisobutylvinyl ether and the like.

### (4) N-Vinyl Compounds

For example, N-vinylcarbazole, N-vinylpyrrolidone, N-vinylindole, N-vinylpyrrole, N-vinylphenothiazine, N-vinylacetanilide, N-vinylethylacetamide, N-vinylsuccinimide, N-vinylphthalimide, N-vinylcaprolactam, N-vinylimidazole and the like.

The content of the above cationic polymerized compound in the cationic polymerization composition is preferably from 1 to 97% by mass and more preferably from 30 to 95% by mass.

The initiator for the photo curable resin of the cationic polymerization system can include aromatic onium salts. This onium salt can include salts of Group Va elements of Periodic Table, e.g., phosphonium salts (e.g., triphenylphenacylphosphonium hexafluorophosphate, an the like), salts of Group VIa elements, e.g., sulfonium salts (e.g., triphenylsulfonium tetrafluoroborate, triphenylsulfonium hexafluorophosphate, tris (4-thiomethoxyphenyl)sulfonium hexafluorophosphate and triphenylsulfonium hexafluoroantimonate, and the like), and salts of Group VIIa elements, e.g., iodonium salts (e.g., diphenyliodonium chloride, and the like). It is described in U.S. Pat. Nos. 4,058,401, 4,069,055, 4,101,513 and 4,161,478 that such aromatic onium salts are used as the cationic polymerization initiator in the polymerization of epoxy compounds.

Preferable cationic polymerization initiators include sulfonium salts of Group VIa elements. Among them, in terms of ultraviolet ray curability and storage stability of ultraviolet ray curable compositions, triarylsulfonium hexafluoroantimonate is preferred. Also it is possible to optionally use the photopolymerization initiators known in the art described in pages 39 to 56 of Photopolymer Handbook (edited by Photopolymer Konwakai (The Technical Association of Photopolymers, Japan), published by Kogyo Chosakai Publishing Co. Ltd., 1989) and the compounds described in Japanese Patent Application No. 64-13142A and No. 2-4804A.

### Other Additives

As the additives to the ink of the invention, it is possible to contain the other additives such as a reaction reducer, a filler, a fluid aid, a thixotropy agent, a wetting agent, a defoaming agent, and a plasticizer. Also stabilizing agents such as a lightfast agent, an ultraviolet absorber, an antioxidant, a polymerization inhibitor and a corrosion inhibitor, or Si compounds, waxes and the like may be added.

### Coloring Materials

As coloring materials of the ink of the invention, it is possible to use dyes and pigments conventionally known. Among them, the pigments are more preferable.

Water soluble dyes include, for example, C.I. direct black-2, -4, -9, -11, -17, -19, -22, -32, -80, -151, -154, -168, -171, -194; C.I. direct blue-1, -2, -6, -8, -22, -34, -70, -71, -76, -78, -86, -112, -142, -165, -199, -200, -201, -202, -203, -207, -218, -236, -287; C.I. direct red-1, -2, -4, -8, -9, -11, -13, -15, -20, -28, -31, -33, -37, -39, -51, -59, -62, -63, -73, -75, -80, -81, -83, -87, -90, -94, -95, -99, -101, -110, -189; C.I. direct yellow-1, -2, -4, -8, -11, -12, -26, -27, -28, -33, -34, -41, -44, -48, -58, -86, -87, -88, -135, -142, -144; D.I. food black-1, -2; C.I. acid black-1, -2, -7, -16, -24, -26, -28, -31, -48, -52, -63, -107, -112, -118, -119, -121, -156, -172, -194, -208; C.I. acid blue-1, -7, -9, -15, -22, -23, -27, -29, -40, -43, -55, -59, -62, -78, -80, -81, -83, -90, -102, -104, -111, -185, -249, -254; C.I. acid red-1, -4, -8, -13, -14, -15, -18, -21, -26, -35, -37, -110, -144, -180, -249, -257; C.I. acid yellow-1, -3, -4, -7, -11, -12, -13, -14, -18, -19, -23, -25, -34, -38, -41, -42, -44, -53, -55, -61, -71, -76, -78, -79, -122 and the like.

Oil soluble dyes include, but are not limited to, azo dyes, metallic complex salt dyes, naphthol dyes, anthraquinone dyes, indigoid dyes, carbonium dyes, quinoimine dyes, cyanine dyes, quinoline dyes, nitro dyes, nitroso dyes, benzoquinone dyes, naphthoquinone dyes, naphthalimide dyes, perinon dyes, phthalocyanine dyes and the like.

Water insoluble dyes and pigments are not especially limited, and include organic pigments, inorganic pigments, colored polymer particles, water insoluble dyes, dispersion dyes, oil soluble dyes and the like. As black pigments, carbon black pigments such as furnace black, lampblack, acetylene black and channel black are included, and for example, it is possible to use Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1255, Raven 1080, Raven 1060 (supplied from Colombian Carbon Inc.); Regal 400R®, Regal 330R®, Regal 660R®, Mogul L®, Black Pearls L®, Monarch 700®, Monarch 800®, Monarch 880®, Monarch 900®, Monarch 1000®, Monarch 1100®, Monarch 1300®, and Monarch 1400® (supplied from Cabot Corporation); Color Black FW1, Color Black FW2, Color Black FW2V, Color Black 18, Color Black FW200, Color Black S150, Color Black S160, Color Black S170, Pritex 35, Pritex U, Pritex Vrintex 140U, Pritex 140V, Special Black 6, Special Black 5, Special Black 4A, Special Black 4 (supplied from Degussa AG); No.25, No.33, No.40, No.47, No.52, No.900, No.2300, MCF-88, MA600, MA7, MA8, MA100 (supplied from Mitsubishi Chemical Corporation). Also as the black pigments, it is possible to use magnetic particles such as magnetite and ferrite, titanium black and the like.

Cyan pigments include C.I. pigment blue-1, C.I. pigment blue-2, C.I. pigment blue-3, C.I. pigment blue-15, C.I. pigment blue-15:1, C.I. pigment blue-15:3, C.I. pigment blue-15:34, C.I. pigment blue-16, C.I. pigment blue-22, C.I. pigment blue-60 and the like.

Magenta pigments include C.I. pigment red-5, C.I. pigment red-7, C.I. pigment red-12, C.I. pigment red-48, C.I. pigment red-48:1, C.I. pigment red-57, C.I. pigment red-112, C.I. pigment red-122, C.I. pigment red-123, C.I. pigment red-146, C.I. pigment red-168, C.I. pigment red-184, C.I. pigment red-202 and the like.

Yellow pigments include C.I. pigment yellow-1, C.I. pigment yellow-2, C.I. pigment yellow-3, C.I. pigment yellow-12, C.I. pigment yellow-13, C.I. pigment yellow-14, C.I. pigment yellow-16, C.I. pigment yellow-17, C.I. pigment yellow-73, C.I. pigment yellow-74, C.I. pigment yellow-75, C.I. pigment yellow-83, C.I. pigment yellow-93, C.I. pigment yellow-95, C.I. pigment yellow-97, C.I. pigment yellow-98, C.I. pigment yellow-114, C.I. pigment yellow-128, C.I. pigment yellow-129, C.I. pigment yellow-151, C.I. pigment yellow-154 and the like.

In addition to the above black and three primary colors of cyan, magenta and yellow, it is also possible to use specific color pigments such as red, green, blue, brown and white, metallic luster pigments such as gold and silver, colorless fillers, plastic pigments and the like. Also, in addition to the above, it is possible to use newly synthesized pigments. Further, these pigments may be those to which surface treatment is given.

The methods for surface treatments include, for example, the treatment with a coupling agent such as an alcohol, an acid, a base and a silane compound, the polymer graft treatment, the plasma treatment and the like.

The coloring materials used in the invention are preferably those where the content of organic and inorganic impurities is low. Since the content of impurities is generally high in the commercially available coloring materials, it is preferable to use refined articles thereof.

The coloring materials used for the above solid ink of the invention is used in the range of typically from 0.1 to 30% by mass, and preferably from 1 to 15% by mass based on the mass of the ink.

### Pigment Dispersion, Dispersed Particle Diameters

It is preferred that the dispersed pigment is used for the ink of the invention.

Dispersing agents used for dispersing the pigment can include, for example, surfactants such as higher fatty acid salts, alkyl sulfate, alkyl ester sulfate, alkyl sulfonate, sulfosuccinate, naphthalene sulfonate, alkyl phosphate, polyoxyalkylene alkyl ether phosphate, polyoxyalkylene alkylphenyl ether, polyoxyethylene polyoxypropylene glycol, glycerine ester, sorbitan ester, polyoxyethylene fatty acid amide and amine oxide, or block copolymers, random copolymers comprising two or more monomers selected from styrene, styrene derivatives, vinylnaphthalene derivatives, acrylic acid, acrylate derivatives, maleic acid, maleate derivatives, itaconic acid, itaconate derivatives, fumaric acid and fumarate derivatives, and salts thereof.

For the dispersion of the pigment, it is possible to use various machines such as a ball mill, sand mill, attritor, roll mill, agitator, Henschel mixer, colloid mill, ultrasonic homogenizer, pearl mill, wet jet mill and paint shaker. Also, it is preferred that crude particles are eliminated from the pigment dispersion using a centrifuging machine or using a filter.

The average particle diameter of the pigment dispersion used for the ink of the invention is preferably from 20 to 200 nm, and more preferably from 20 to 100 nm. When the average particle diameter is less than 20 nm, an image storage ability comes to deteriorate. Also, when it is more than 200 nm, an injection stability comes to deteriorate.

An added amount of the pigment dispersion used for the ink of the invention is generally in the range of preferably from 0.5 to 30% by mass, and more preferably from 1 to 20% by mass. When the added amount of the pigment used for the ink is less than 0.5% by mass, the large amount of the ink is required for obtaining an image density. Also when it is more than 30% by mass, the injection stability comes to deteriorate.

It is possible to add water soluble organic solvent to the ink of the invention if necessary. The water soluble organic solvent preferably used include, for example, alcohols (e.g., methanol, ethanol, propanol, isopropanol, butanol, isobutanol, secondary butanol, tertiary butanol, pentanol, hexanol, cyclohexanol, benzyl alcohol, and the like); polyalcohols (e.g., ethyleneglycol, diethyleneglycol, triethyleneglycol, polyethyleneglycol, propyleneglycol, dipropyleneglycol, polypropyleneglycol, butyleneglycol, hexanediol, pentanediol, glycerine, hexanetriol, thiodiglycol, and the like); polyalcohol ethers (e.g., ethyleneglycol monomethylether, ethyleneglycol monoethylether, ethyleneglycol monobutylether, diethyleneglycol monomethylether, diethyleneglycol monoethylether, diethyleneglycol monobutylether, propyleneglycol monomethylether, propyleneglycol monobutylether, ethyleneglycol monomethylether acetate, triethyleneglycol monomethylether, triethyleneglycol monoethylether, triethyleneglycol monobutylether, ethyleneglycol monophenylether, propyleneglycol monophenylether, and the like); amines (e.g., ethanolamine, diethanolamine, triethanolamine, N-methyldiethanolamine, N-ethyldiethanolamine, morpholine, N-ethylmorpholine, ethylenediamine, diethylenetriamine, triethylenetetraamine, tetraethylenepentamine, polyethyleneimine, pentamethyldiethylenetriamine tetramethylpropylenediamine, and the like); amides (e.g., formamide, N,N-dimethylformamide, N,N-dimethylacetamide, and the like); heterocyclic compounds (e.g., 2-pyrrolidone, N-methyl-2-pyrrolidone, cyclohexylpyrrolidone, 2-oxazolidone, 1,3-dimethyl-2-imidazolidinone, and the like); sulfoxides (e.g., dimethyl sulfoxide, and the like); sulfones (e.g., sulforane, and the like); urea; acetonitrile; acetone; and the like.

In addition thereto, a preservative, a mildew proof agent, a viscosity adjuster and the like may be contained in the ink of the invention if necessary.

### pH

The pH of the ink of the invention is preferably from 4 to 10. More preferably it is from 5 to 9. When the pH is out of the above range, dispersibility of the pigment is sometimes deteriorated.

### Surface Tension

For the ink of the invention, the surface tension of the ink is preferably in the range of 20 to 60 mN/m, and more preferably, is set in the range of 25 to 50 mN/m in consideration of wettability for a recording medium and a nozzle. When the surface tension of the ink is less than 20 mN/m, the ink is easily spilt over, and when it is more than 60 mN/m, drying time becomes long.

To regulate the surface tension, surfactants may be contained if necessary. The surfactants preferably used for the ink of the invention include, for example, anionic surfactants such as dialkylsulfosuccinates, alkylnaphthalenesulfonates and fatty acid salts; nonionic surfactants such as polyoxyethylene alkyl ethers, polyoxyethylene alkylallyl ethers, acetylene glycols and polyoxyethylene/polyoxypropylene block copolymers; cationic surfactants such as alkyl amine salts and quaternary ammonium salts. Among them especially, anionic and nonionic surfactants are preferable.

### Discharge Amount

In the image recording method of the invention, it is preferred that an amount of one drop jetted from a nozzle (jet volume) is from 1 to 6 pico-liter. When the jet volume is more than 6 pico-liter, highly fine printing becomes difficult, and when it is less than 1 pico-liter, the density of formed image becomes low.

### Dot Diameter

In the image recording method of the invention, the dot diameter formed on the recording medium is preferably from 50 to 200 μm, more preferably from 50 to 150 μm, and especially preferably from 55 to 100 μm.

Here, when the dot diameter is less than 50 μm, the density of formed image becomes low, and when it is more than 200 μm, highly fine printing becomes difficult.

### Active Energy Ray Radiating Member (Radiation Source)

In the image recording method of the invention, as described above, an image is formed on the recording medium, and subsequently the image can be cured by radiating ultraviolet ray, electron ray, X ray, visible light, infrared light and the like as active energy ray. However, when curability and cost of the radiation source are considered, the ultraviolet ray is preferable. As the radiating member by which the ultraviolet ray is radiated (ultraviolet ray radiation source), it is possible to use a mercury lamp, a metal halide lamp, an excimer lamp, an ultraviolet laser/LED and the like.

The basic radiation method is disclosed in Japanese Patent Application 60-132767A. According to this, a light source is installed at both side of the head unit, and the head and the light source are scanned by a shuttle mode. After receiving the ink on the recording medium, a certain amount of time is kept, and subsequently the radiation is carried out. Further, the curing is completed by another light source with no driving. WO 9,954,415 has disclosed the method using optic fibers as the radiation method, and the method where the ultraviolet light is radiated to the recording portion by applying collimated light source to a mirror face installed at the side face of the head unit. In the image recording method of the invention, it is possible to use these radiation methods.

Specifically, zonal metal halide lamp tubes and ultraviolet lamp tubes are preferable. The radiation source can be made an inexpensive configuration by substantially being fixed to the recording device to remove a mobile portion.

The radiation is preferably carried out for every printing of each color. That is, it is one of preferable forms that two types of the radiation sources are prepared and the curing is completed by the second radiation source in any exposure modes. This contributes to wettability of the jetted ink of the second color, obtaining adhesiveness between the inks, and setting up the inexpensive radiation source.

It is preferred that exposure wavelengths or exposure illumination intensities are different between the first and second radiation sources. The first radiation energy is made smaller than the second radiation energy, i.e., the first radiation energy is typically made from 1 to 20%, preferably from 1 to 10%, and more preferably from 1 to 5% of the total radiation energy. Performing the radiation with different illumination intensities makes molecular distribution after curing preferable, and remarkable effects are obtained in the composition where the viscosity is extremely low such as ink jet inks. On the other hand, when the radiation with the high illumination intensity is performed at a time, a polymerization rate is increased, but the molecular weight of polymerized polymer is small and the strength can not be obtained.

Also, by making the first radiation a longer wavelength compared to the second radiation, the first radiation cures a surface layer of the ink to restrain the bleeding of ink, and the second radiation cures the ink closed to the recording medium where the radiation ray is hard to reach to be able to improve cohesiveness. Also for facilitating the curing within the ink, it is preferred that the wavelength of the second radiation is the long wavelength.

### Radiation Timing

In the image recording method of the invention, it is preferred that using the above ink and warming the ink to a constant temperature, the above active energy ray is radiated typically from 0.01 to 0.5 seconds, preferably from 0.01 to 0.3 seconds, and more preferably from 0.01 to 0.15 seconds after receiving ink on the recording medium.

This way, it becomes possible to prevent bleeding of the jetted ink before the curing by controlling the time from the receiving of ink to the radiation to an extremely short time. Also, since the exposure can be carried out even for porous recording media before the ink soaks into the deep portion which the light source does not reach, residual unreacted monomer can be restrained to reduce odors. This brings large synergistic effects by the use of the ink of the invention. The large effects can be obtained especially when using the ink where the ink viscosity is from 10 to 500 mPa.s at 30° C. By applying such a recording method, the dot diameters of the jetted ink can be retained to be constant for various recording media where surface wettability is different, and the image quality is improved.

To obtain color printed images, it is preferred that colors are overlaid in order starting from the color with low brightness. When the colors with low brightness are overlaid, the active energy ray unlikely reaches underneath inks, as well as the inhibition of curing sensitivity, the increase of residual monomers and the occurrence of odors and the coherent deterioration easily occur. Also, the radiation can be carried out by exposing collectively after injecting all colors, but it is preferred to exposure color by color in terms of facilitating the curing.

Also, in the unit made up of multiple color heads, it is preferred that a member between color heads has a substantially active energy ray transmitting property. Specifically, those between the heads are configured with active energy ray transmitting members, or they are the configurations where no member is disposed.

In the image recording method of the invention, it is possible to radiate rapidly color by color immediately after receiving of ink, by making such a simple configuration. Especially, it is preferred to be able to prevent the bleeding of the secondary colors and the forward and backward differences of dot bleeding in the bi-directional drawing (prevent the forward and backward colors from being different).

Next, an image formation onto the recording medium R by the ink jet printer A of the invention (image recording method) is illustrated in reference to FIGS. 1, 2A and 2B.

The ink jet printer A becomes a state capable of forming images by setting an ink cartridge, the recording medium R and the like, and turning on the power.

When the ink is supplied from the ink cartridge, the control unit 30 detects an ink temperature in a common liquid chamber 2g on the basis of a detection result of a head temperature sensor. And, CPU of a head temperature controlling section selects heating temperature data, and controls an output state of a heater on the basis of the selected heating temperature data to heat such that the inks in the common liquid chamber 2g are within the predetermined temperature range.

Next, in the ink jet printer A, a front edge of the recording medium R set at a spindle (not shown) is introduced along a paper feeding guide (not shown) to a carrier roller 1a, the positioning of the front edge of the recording medium R is carried out.

The positioned recording medium R is fed to an image forming section 2 by the carrier roller 1a. The UV ink is jetted from a recording head 21 to the recording medium R at the image forming section 2. At that time, the recording head 21 jets ink to the recording medium R with moving on the predetermined range of the recording medium R by actuating the carriage 22, by being controlled on the basis of image data to be printed.

The recording medium R is further supported at side of the non-image forming surface by the guide member 4, guided to the feeding direction F, and fed to directly below a UV lamp 3.

Subsequently, UV from the UV lamp 3 is radiated to the recording medium R fed to directly below the UV lamp 3, in other words, the recording medium R onto which the UV inks adhere, to cure the UV inks which adhere onto the recording medium R. After the above steps are carried out, the recording medium R is discharged by passing through a discharging guide (not shown).

### EXAMPLES

Examples of the ink jet printer A of the above embodiments are illustrated below.

### Ink Set 1

First, the ink set 1 containing the radical polymerizable composition was prepared according to the following method.

### Preparation of Pigment Dispersions

Each composition described below was formulated by a pressure kneader and the viscosity was made 106 mPa.s or more. Then, each pigment dispersion 1 was prepared by milling and dispersing with two roll mills. The temperature in these steps was controlled not to exceed 80° C.

(Preparation of black pigment dispersion 1)

| | |
|---|---|
| Pigment black 7 (Carbon black) | 70 parts by mass |
| Styrene/acrylate ester copolymer (acid value < 1) | 10 parts by mass |
| Phenoxypolyethylene glycol acrylate | 20 parts by mass |
| Polymerization inhibitor (supplied from Sumitomo | 0.1 part by mass |
| Chemical Co., Ltd., Sumilizer GS) | |

(Preparation of yellow pigment dispersion 1)

| | |
|---|---|
| Pigment yellow 93 | 70 parts by mass |
| Nonionic dispersing agent | 10 parts by mass |
| Phenoxypolyethylene glycol acrylate | 20 parts by mass |
| Polymerization inhibitor (supplied from Sumitomo | 0.1 part by mass |
| Chemical Co., Ltd., Sumilizer GS) | |

(Preparation of magenta pigment dispersion 1)

| | |
|---|---|
| Pigment violet 19 | 70 parts by mass |
| Nonionic dispersing agent | 10 parts by mass |
| Phenoxypolyethylene glycol acrylate | 20 parts by mass |
| Polymerization inhibitor (supplied from Sumitomo | 0.1 part by mass |
| Chemical Co., Ltd., Sumilizer GS) | |

(Preparation of cyan pigment dispersion 1)

| | |
|---|---|
| Pigment blue 15:3 | 70 parts by mass |
| Nonionic dispersing agent | 10 parts by mass |
| Phenoxypolyethylene glycol acrylate | 20 parts by mass |
| Polymerization inhibitor (supplied from Sumitomo | 0.1 part by mass |
| Chemical Co., Ltd., Sumilizer GS) | |

(Preparation of white pigment dispersion 1)

| | |
|---|---|
| Pigment white (titanium oxide) | 85 parts by mass |
| Nonionic dispersing agent | 10 parts by mass |
| Phenoxypolyethylene glycol acrylate | 10 parts by mass |
| Polymerization inhibitor (supplied from Sumitomo | 0.1 part by mass |
| Chemical Co., Ltd., Sumilizer GS) | |

### Preparation of the Ink Set 1

The inks of respective colors (black ink 1, yellow ink 1, magenta ink 1, cyan ink 1 and white ink 1) were prepared using various pigment dispersions 1 prepared above at the composition described in Table 1.

That is, it was confirmed that all additives except for the pigment dispersions were formulated and thoroughly dissolved. Then, the liquid temperature was 50° C., the above respective pigment dispersions were gradually added and thoroughly stirred using a dissolver. Subsequently, filtration was carried out using a filter of 0.8 μm. As the pretreatment, the filtration was also carried out using a filter of 10 μm. In the above filtration step, there were few occurrences of pressure loss and sufficient filtration rates were obtained.

Then, dissolved air and water were eliminated by warming the resultant solution up to 50° C. and reducing pressure with stirring to prepare each ink. The viscosity of each ink at 25° C. was in the range of 12 to 22 mPa.s, the surface tension thereof was in the range of 24 to 30 dyn/cm, the average particle diameter was in the range of 0.08 to 0.3 μm, and the moisture content was in the range of 0.7 to 1.2%.

TABLE 1

| | Pigment dispersion | | | | | | |
|---|---|---|---|---|---|---|---|
| | | Con- | Additives (%) | | | | |
| Name of | | tent | DPCA- | | | | |
| ink | Type | (%) | 60 | TEGDA | PO-A | I369 | MEK |
| Black ink | Black pig- | 4 | 25 | 25 | 41 | 5 | 0 |
| 1 | ment disp. 1 | | | | | | |
| Yellow | Yellow pig- | 4 | 25 | 25 | 41 | 5 | 0 |
| ink 1 | ment disp. 1 | | | | | | |
| Magenta | Magenta pig- | 4 | 25 | 25 | 41 | 5 | 0 |
| ink 1 | ment disp. 1 | | | | | | |
| cyan ink | Cyan pig- | 3 | 25 | 25 | 42 | 5 | 0 |
| 1 | ment disp. 1 | | | | | | |
| White ink | White pig- | 7 | 25 | 25 | 38 | 5 | 0 |
| 1 | ment disp. 1 | | | | | | |
| Black ink | Black pig- | 4 | 25 | 25 | 31 | 5 | 10 |
| 2 | ment disp. 1 | | | | | | |
| Yellow | Yellow pig- | 4 | 25 | 25 | 31 | 5 | 10 |
| ink 2 | ment disp. 1 | | | | | | |
| Magenta | Magenta pig- | 4 | 25 | 25 | 31 | 5 | 10 |
| ink 2 | ment disp. 1 | | | | | | |
| Cyan ink | Cyan pig- | 3 | 25 | 25 | 32 | 5 | 10 |
| 2 | ment disp. 1 | | | | | | |
| White ink | White pig- | 7 | 25 | 25 | 28 | 5 | 10 |
| 2 | ment disp. 1 | | | | | | |

Details of each additive described in Table 1 are as follows.

DPCA60: supplied from Nippon Kayaku, KAYARAD DPCA (caprolactam modified dipentaerythritol hexaacrylate)

TEGDA: supplied from Osaka Organic Chemical Industry Ltd., Viscoat #335HP (tetraethyleneglycol diacrylate)

PO-A: supplied from Kyoeisha Chemical Co. Ltd., Light acrylate PO-A (phenoxyethyl acrylate)

I369: supplied from Chiba Specialty Chemicals, Irgacure 369 (2-benzyl-2-dimethylanimo-1-(4-morpholinophenyl)-butanone-1)

MEK: Methylethyl ketone

### Ink Set 2

Next, the ink set 2 containing volatile components was prepared.

### Preparation of Pigment Dispersions

As each pigment dispersion used, the same pigment dispersions as those in the ink set 1 were used, and prepared under the same condition.

### Preparation of the Ink Set 2

Also, the inks of respective colors (black ink 2, yellow ink 2, magenta ink 2, cyan ink 2 and white ink 2) were prepared using various pigment dispersions 1 prepared above at the composition described in Table 1.

### Ink Set 3

Next, the ink set 3 containing the cationic polymerization composition was prepared.

### Preparation of Pigment Dispersions

Each pigment dispersion 3 was prepared under the same condition, by changing phenoxypolyethylene glycol acrylate which is the composition of the pigment dispersions 1 in the ink set 1, to OXT-221, and thus the detailed formulations thereof are omitted.

### Preparation of the Ink Set 3

The inks of respective colors (black ink 3, yellow ink 3, magenta ink 3, cyan ink 3 and white ink 3) were similarly prepared using various pigment dispersions 3 prepared above by the composition described in Table 2.

TABLE 2

| | | | Photo | | | |
|---|---|---|---|---|---|---|
| | color material | | Polymerized | Acid | | Initiator |
| Name of | | Added | compound | Compound | Initiator | aid |
| ink | Type | Amount | OXT221 | 1 | SP152 | *1 |
| Black ink | Black pigment | 5 | 90 | 90 | 1 | 1 |
| 3 | disp. 3 | | | | | |
| Yellow | Yellow pigment | 2.5 | 93 | 93 | 0.5 | 1 |
| ink 3 | disp. 3 | | | | | |
| Magenta | Magenta pigment | 3 | 92.5 | 92.5 | 0.5 | 1 |
| ink 3 | disp. 3 | | | | | |
| Cyan ink | Cyan pigment | 2.5 | 93 | 93 | 0.5 | 1 |
| 3 | disp. 3 | | | | | |
| White ink | White pigment | 7 | 87.5 | 87.5 | 0.5 | 1 |
| 3 | disp. 3 | | | | | |

The details of the additives in Table 2 are as follows.

OXT: supplied from Toagosei Co. Ltd., oxetane compound, OXT-221 (di[1-ethyl (3-oxetanyl)] methyl ether)

The compound (1) is the sulfonated compound represented below.

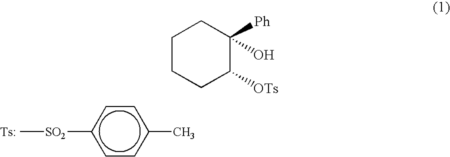

Initiator aid *1: diethylthiochitosan

### Image Formation by the Ink Jet Printer A

Next, the image formation for the recording medium R by the ink jet printer A was carried out. In the ink jet printer A, an ink supplying system which supplies the UV inks to the recording head 21 was formed by an ink tank, a supplying pipe, a front chamber ink tank and piping with filters. Further, the above ink supplying system comprises heat insulting materials and heaters over nearly all routes and controlled the temperature such that the temperature of the UV inks inside the supplying pipe is 60±2° C.

A piezo type of 128 nozzle was used for the nozzle 2j.

The recording head 21 was actuated at an actuating frequency of 10 kHz so as to inject at a resolution of 720×720 dpi (dpi refers to the dot number per 2.54 cm).

Evaluations were carried out in a five-full color printer having five color heads of black (K), yellow (Y), magenta (M), cyan (C) and white (W) at the carriage 22. A low pressure mercury lamp 3 which emits UV-A light was provided at both sides of the carriage 22, and the recording heads 21 were scanned such that the UV light could be radiated within 1000 ms after the receiving of inks on the recording medium R.

The illumination intensity at the exposed face was rendered 1000 mW/cm². The change of the exposing energy was carried out by changing the speed of the recording heads 21. An integrated quantity of light radiated to all inks was made possible to regulate up to 50 to 600 mJ/cm². A point where surface tackiness disappeared was a sensitivity. The levels of the sensitivity of various inks obtained from the above were from 100 to 170 mJ/cm².

As the recording medium R, one where the plasma treatment was given to the surface of OPS such that a wettability index became 46 dyn/cm, was used.

Under the condition mentioned above, the image was formed on the recording medium R by changing the diameter of the nozzle 2j (diameter of the jetting opening), the drop volume (volume of one drop of the ink jetted from the jetting opening 201), and the ink set (ink set 1 to 3). Then the clogging of the nozzle opening, density unevenness and character quality were evaluated, and the results were shown in Table 3. The nozzles 1 and 2 shown in Table 3 indicate those in FIGS. 8 and 3B, respectively.

### Clogging of the Nozzle Opening

Continuous recording for 30 minites was carried out, and the number and the frequency of the occurrences of the clogging of the nozzle opening were evaluated.

“E1”: No clogging of the nozzle opening

“E2”: No clogging of the nozzle opening but satellite occurs

“E3”: Occurrence of 5 or less of the clogging of the nozzle opening

“E4”: Occurrence of 6 or more of the clogging of the nozzle opening

### Density Unevenness

Solid density (density at the even highest density area) was measured for 10 points using a densitometer (Spectrolino supplied from Gretag Co.), and density unevenness was evaluated.

“E1”: Good within ±0.07

“E2”: No practical problem within ±0.10

“E3”: Practically slightly problematic, more than ±0.10 but within ±0.15

“E4”: Practically problematic, more than ±0.15

### Character Quality

For black (K), magenta (M) and cyan (C), MS Minchotai characters at 6 point were printed at an aimed density, respectively, then roughness and break of characters were magnified by a magnifier, observed and evaluated.

“E1”: No roughness and break

“E2”: Slightly rough

“E3”: Rough and the characters are slightly broken

“E4”: Rough and the characters are broken

TABLE 3

| | | | | | clogging | | |
|---|---|---|---|---|---|---|---|
| | | Nozzle | Amount | Shape | of the | Density | |
| | | diameter | droplet | of | nozzle | uneven- | Character |
| | Ink set | (μm) | (pl) | Nozzle | opening | ness | quality |
| Example 1 | Ink set | 20 | 6 | Nozzle | E2 | E2 | E2 |
| | 1 | | | 1 | | | |
| Comparative | Ink set | 20 | 14 | Nozzle | E3 | E3 | E3 |
| Example 1 | 1 | | | 1 | | | |
| Comparative | Ink set | 25 | 6 | Nozzle | E2 | E4 | E3 |
| Example 2 | 1 | | | 1 | | | |
| Comparative | Ink set | 20 | 6 | Nozzle | E4 | E4 | E4 |
| Example 3 | 2 | | | 1 | | | |
| Example 2 | Ink set | 20 | 6 | Nozzle | E1 | E2 | E2 |
| | 1 | | | 2 | | | |
| Example 3 | Ink set | 20 | 6 | Nozzle | E2 | E1 | E1 |
| | 3 | | | 1 | | | |

From the results in Table 3, the evaluation of at least “E2” or more was given to the parameters of the clogging of the nozzle opening, the density unevenness and the character quality in the examples 1 to 3 where the nozzle diameter was set at from 12 μm or more to 22 μm or less and the volume of a drop was set at from 1 pico-liter to 6 pico-liter regardless of the shape of nozzle (nozzle 1, nozzle 2), which were the inks containing no volatile component.

On the other hand, the evaluation of “E3” was given to the above all three parameters in the comparative example 1 where the volume of a drop was set at 14 μm.

The evaluation of “E3” or less was given to the parameters of the density unevenness and the character quality in the comparative example 2 where the nozzle diameter was set at 25 μm.

The evaluation of “E4” was given to the above all three parameters in the comparative example 3 using the inks containing the volatile component.

Also, the evaluation of “E2” was given to the parameters of the density unevenness and the character quality in the examples 1 and 2 containing the radical polymerizable composition. On the other hand, the evaluation of “E1” was given to the same parameters in the example 3 containing cationic polymerization composition.

Further, the evaluation of “E2” was given to the parameter of the clogging of the nozzle opening in the examples 1 and 3 using the nozzle 1. On the other hand, the evaluation of “E1” was given to the same parameter in the example 2 using the nozzle 2.

From the above, it has been confirmed that no clogging of the nozzle opening occurs, a small volume of drop can be jetted from the jetting opening with a small diameter, no density unevenness occurs, the character quality is not reduced and high quality image can be made by making the inks containing no volatile component, making the nozzle diameter from 12 μm or more to 22 μm or less, and making the amount of a droplet from 1 pico-liter or more to 6 pico-liter or less.

Especially, it has been found that the inks containing the cationic polymerization composition are more preferable than those containing the radical polymerizable composition as the inks used. Further, about the shape of nozzle, it has been found that as shown in FIG. 3B, a supply opening 202 side differs from a jetting opening 201 side in an angle of an inner circumferential surface of the nozzle with respect to a center line of the nozzle.

The entire disclosure of Japanese Patent Application No. Tokugan 2002-250473 filed on Aug. 29, 2002 including specification, claims, drawings and summary are incorporated herein by reference in its entirety.

What is claimed is:

1. An ink jet printer comprising:
a recording head on which a plurality of nozzles for jetting ink are arranged; and
a feeding member for feeding a recording medium,
wherein an image is recorded by jetting the ink from the nozzles of the recording head to the recording medium fed by the feeding member;
wherein a jetting opening of each nozzle, from which the ink is jetted, has a diameter of not less than 12 μm and not more than 22 μm, and the ink substantially includes no volatile component.

2. The ink jet printer of claim 1; wherein a volume of a drop of the ink jetted from the nozzle is not less than 1 pico-liter and not more than 6 pico-liter.

3. The ink jet printer of claim 1; wherein a supply opening side of each nozzle, to which the ink is supplied, differs from a jetting opening side of each nozzle in an angle of an inner circumferential surface of the nozzle with respect to a center line of the nozzle.

4. The ink jet printer of claim 1, further comprising:
a head temperature adjusting mechanism arranged in the neighborhood of the jetting opening, for adjusting a temperature of the ink at the jetting opening to not less than 30° C.

5. The ink jet printer of claim 1; wherein a viscosity of the ink is not less than 20 mPa.s and not more than 200 mPa.s at 25° C., and the viscosity of the ink is not less than 8 mPa.s and not more than 30 mPa.s when the ink is jetted from each nozzle.

6. The ink jet printer of claim 1; wherein the ink includes an active energy ray curable compound.

7. The ink jet printer of claim 6, further comprising:
an active energy ray radiating member for radiating an active energy ray to the recording medium to which the ink is jetted from the nozzle, in order to harden the active energy ray curable compound.

8. An image recording method comprising: forming an image by jetting ink to a recording medium with the ink jet printer of claim 1.

9. A recording head comprising: a plurality of nozzles for jetting ink,
wherein a jetting opening of each nozzle, from which the ink is jetted, has a diameter of not less than 12 μm and not more than 22 μm.

10. The recording head of claim 9; wherein a volume of a drop of the ink jetted from the nozzle is not less than 1 pico-liter and not more than 6 pico-liter.

11. The recording head of claim 9; wherein a supply opening side of each nozzle, to which the ink is supplied, differs from a jetting opening side of each nozzle in an angle of an inner circumferential surface of the nozzle with respect to a center line of the nozzle.

12. The recording head of claim 9, further comprising;
a head temperature adjusting mechanism arranged in the neighborhood of the jetting opening of the nozzle, for adjusting a temperature of the ink at the jetting opening to not less than 30° C.

13. Ink for an ink jet printer, including color material,
wherein the ink substantially includes no volatile component.

14. The ink of claim 13; wherein a viscosity of the ink is not less than 20 mPa.s and not more than 200 mPa.s at 25° C., and the viscosity of the ink is not less than 8 mPa.s and not more than 30 mPa.s when the ink is jetted from a nozzle of the ink jet printer.

15. The ink of claim 13; wherein the ink includes an active energy ray curable compound.
